(19) United States
(12) Patent Application Publication
(10) Pub. No.: US 2026/0274707 A1
(43) Pub. Date: Sep. 17, 2026

(54) PARTICULATE MATERIAL COMPRISING SILVER PARTICLES WHICH ARE EQUIPPED WITH RUTHENIUM OXIDE AND ARE OPTIONALLY PARTIALLY OXIDIZED

(71) Applicant: HERAEUS PRECIOUS METALS GMBH & CO. KG, Hanau (DE)

(72) Inventors: Michael GOCK, Hanau (DE); Milena KOVJENIC, Hanau (DE); Marie-Lena HARWARDT, Hanau (DE); Ana-Lucia MEZA-CHINCHA, Hanau (DE); Matthias HÖRTEIS, Hanau (DE); Christian IMGRUND, Hanau (DE)

(21) Appl. No.: 19/153,511

(22) PCT Filed: Jul. 28, 2023
(86) PCT No.: PCT/EP2023/070980

§ 371 Date: Aug. 4, 2025

(30) Foreign Application Priority Data
Feb. 9, 2023 (EP) 23155706.7

(51) Int. Cl. C01G 55/00; C01G 5/00

(52) U.S. Cl. CPC C01G 55/004; C01G 5/00; C01P 2004/61; C01P 2004/62; C01P 2004/82

(57) ABSTRACT

The invention relates to a particulate material which has an average particle size (d50) ranging from 1 to 100 μm, said material comprising silver particles which are equipped with ruthenium oxide and are optionally partially oxidized. The particulate material can be produced by means of a drying process and a thermolytic treatment, which is carried out in a non-reducing atmosphere, of an aqueous suspension comprising water, silver particles, and at least one ruthenium oxide precursor in the form of a ruthenium compound which can be thermally decomposed into ruthenium oxide in a non-reducing atmosphere.

The invention relates to a particulate material comprising silver particles which are equipped with ruthenium oxide (RuO₂) and are optionally partially oxidized and to an efficient method for the production thereof.

EP 3 915 376 A1 discloses a hybrid material which can be used as an antimicrobial, antiviral and/or fungicidal additive and comprises particles each comprising at least one carrier material which is coated at least in part with at least two different metals. The metals are in electrically conductive contact with each other, at least by means of their respective surfaces. The first metal comprises at least one transition metal element which has a plurality of oxidation states and allows a change of oxidation states via catalytically active centers, for example ruthenium. The second metal, for example silver, comprises at least one electrically conductive silver semiconductor, the two metals forming half-elements that are short-circuited in the presence of water and oxygen.

The object of the invention was to provide a material comprising silver and ruthenium which is highly antimicrobially effective and can be produced easily and efficiently.

The object can be achieved by providing a particulate material comprising silver particles which are equipped with ruthenium oxide and are optionally partially oxidized, hereinafter also referred to simply as “particulate material according to the invention.”

The expression “equipped with ruthenium oxide” used in this patent application means that the ruthenium oxide is present on the outer surface of the optionally partially oxidized silver particles. The ruthenium oxide can, for example, form a discontinuous layer and/or small ruthenium oxide particles (ruthenium oxide islands).

The particulate material according to the invention has an average particle size (d50) ranging from 1 to 100 μm, preferably 1 to 20 μm. Its silver: ruthenium weight ratio can be in the range of, for example, 1 to 2000 parts by weight of silver: 1 part by weight of ruthenium.

The term “average particle size” used herein means the volume-average primary particle diameter (d50) determinable by means of laser diffraction. In this case, what is known as Equivalent Circular Area Diameter (ECAD) can advantageously be used as a measure of the particle diameter (cf. RENLIANG XU ET AL: “Comparison of sizing small particles using different technologies,” POWDER TECHNOLOGY, ELSEVIER, BASEL (CH), vol. 132, no. 2-3, Jun. 24, 2003 (2003-06-24), pages 145-153). Laser diffraction measurements can be carried out using a corresponding particle size measuring instrument, for example a Mastersizer 3000 or Mastersizer 2000 from Malvern Instruments according to the wet determination process. In the wet determination process, a particulate sample can be dispersed in ethanol by means of ultrasound as part of the preparation of the sample.

The particulate material according to the invention comprises particles consisting of silver particles which are equipped with ruthenium oxide and are optionally partially oxidized. The wording “optionally partially oxidized” refers to two embodiments. In a first embodiment, the silver particles may be equipped with ruthenium oxide; in this embodiment, the silver particles consist of elemental metallic silver (non-oxidized silver particles). In a second embodiment, the silver particles may be equipped with ruthenium oxide and be partially oxidized; the term “partially oxidized silver particles” refers to particles of elemental metallic silver which comprise silver oxide on their surface; more precisely, these are particles consisting of a silver core with a silver oxide layer partially or completely surrounding the silver core. The silver oxide layer may have been formed on the surface of the silver core by oxidation, for example during the production of the particulate material according to the invention. The silver oxide layer can be detected using conventional surface technology examination methods such as SEM (scanning electron microscopy) or XPS (X-ray photoelectron spectroscopy).

The particulate material according to the invention in its first embodiment of silver particles equipped with ruthenium oxide can also comprise silver particles and/or ruthenium oxide particles. However, the material consists at least mainly, for example ≥90 to ≤100 wt. %, of silver particles equipped with ruthenium oxide; accordingly, the ≥0 to ≤10 wt. % portion can consist of silver particles and/or ruthenium oxide particles, each present separately. Furthermore, the particulate material according to the invention in its first embodiment does not comprise any deliberately added material or substances, in particular no material or substances which could serve as a carrier material; rather, the silver particles themselves serve as a carrier material for the ruthenium oxide. Needless to say for the person skilled in the art, the expression “no deliberately added material or substances” also excludes any deliberately carried out chemical manipulation of the particulate material according to the invention in its first embodiment that leads to addition or modification of material or substances.

The particulate material according to the invention in its second embodiment of silver particles which are equipped with ruthenium oxide and are partially oxidized can also comprise partially oxidized silver particles, non-oxidized silver particles and/or ruthenium oxide particles. However, the material consists at least mainly, for example ≥90 to ≤100 wt. %, of silver particles which are equipped with ruthenium oxide and are partially oxidized; accordingly, the ≥0 to ≤10 wt. % portion can consist of partially oxidized silver particles, non-oxidized silver particles and/or ruthenium oxide particles, each present separately. Furthermore, the particulate material according to the invention in its second embodiment does not comprise any deliberately added material or substances, in particular no material or substances which could serve as a carrier material; rather, the partially oxidized silver particles themselves serve as a carrier material for the ruthenium oxide. Needless to say for the person skilled in the art, the expression “no deliberately added material or substances” also excludes any deliberately carried out chemical manipulation of the particulate material according to the invention in its second embodiment that leads to addition or modification of material or substances.

The ruthenium oxide of the silver particles which are equipped therewith and are optionally partially oxidized is present on the outer surface of the optionally partially oxidized silver particles and can, for example, form a discontinuous layer and/or small ruthenium oxide particles (ruthenium oxide islands); the optionally partially oxidized silver particles themselves act as a carrier material, as already mentioned. SEM may be a suitable process for observing such morphological properties.

The invention also relates to a method for producing the particulate material according to the invention. In the method according to the invention, the particulate material according to the invention can be obtained in the course of a drying process and a thermolytic treatment, which is carried out in a non-reducing atmosphere, of an aqueous suspension comprising water, silver particles, and at least one ruthenium oxide precursor. Thermolytic treatment is a treatment at or above the thermolysis temperature of the ruthenium oxide precursor(s), i.e., the minimum object temperature that ensures thermal decomposition of the ruthenium oxide precursor(s) into ruthenium oxide in a non-reducing atmosphere.

The term “non-reducing atmosphere” as used repeatedly herein refers to an oxidizing or inert atmosphere. The term “oxidizing atmosphere” refers to an atmosphere consisting of a gas comprising oxidizing properties, such as oxygen, air or a gas mixture of oxygen and one or more inert gases such as nitrogen, argon and/or carbon dioxide; the volume fraction of oxygen within such a gas mixture with inert gas can be in the range of, for example, 10 to 30 vol. %. The term “inert atmosphere” refers to an atmosphere consisting of one or more inert gases such as nitrogen, argon and/or carbon dioxide.

In the method according to the invention, silver particles and at least one ruthenium oxide precursor are used.

The silver particles mentioned herein or the silver particles used as a starting material in the method according to the invention are those with an average particle size (d50) ranging, for example, from 0.5 μm to 50 μm. The silver particles can have a variety of shapes, for example they can be spherical, substantially spherical, elliptical, ovoid, flake-shaped or have an irregular shape. The silver particles are expediently uncoated and they may comprise particles of pure silver (silver purity of at least 99.9 wt. %) and/or those of silver alloys containing up to 10 wt. % of at least one other alloying metal. In other words, the silver particles are expediently uncoated particles of pure silver (silver purity of at least 99.9 wt. %) and/or those of silver alloys with up to 10 wt. % of at least one other alloying metal. Examples of suitable alloying metals are copper, gold, nickel, palladium, platinum and aluminum. Silver particles consisting of pure silver are preferred. Silver particles are commercially available. An example is the silver powder “Ag 300-01” from Heraeus Electronics. Similar powders are also available from other companies.

The ruthenium oxide precursor(s) used in the method according to the invention are ruthenium compounds which can be thermally decomposed into ruthenium oxide in a non-reducing atmosphere.

All ruthenium compounds which can be thermally decomposed into ruthenium oxide in a non-reducing atmosphere can be thermolytically treated in the method according to the invention in an oxidizing atmosphere and in the process be thermally decomposed into ruthenium oxide. A person skilled in the art can easily determine such suitability of a ruthenium compound for thermal decomposition into ruthenium oxide in an oxidizing atmosphere, for example by thermogravimetry in an oxidizing atmosphere. Examples of ruthenium compounds which are suitable in the context as ruthenium oxide precursors include ruthenium nitrosyl nitrate, ruthenium oxalate, ruthenium acetate and in particular ruthenium nitrosyl oxalate.

Some ruthenium compounds which can be thermally decomposed into ruthenium oxide in a non-reducing atmosphere can be thermolytically treated in the method according to the invention even in an inert atmosphere and in the process be thermally decomposed into ruthenium oxide. A person skilled in the art can easily determine such suitability of a ruthenium compound for thermal decomposition into ruthenium oxide in an inert atmosphere, for example by thermogravimetry in an inert gas atmosphere. Examples of ruthenium compounds that are suitable in this regard include ruthenium nitrosyl nitrate and in particular ruthenium nitrosyl oxalate.

The production method according to the invention comprises providing an aqueous suspension comprising water, silver particles, and at least one ruthenium oxide precursor, as well as drying and thermolytically treating the aqueous suspension in a non-reducing atmosphere. Drying and thermolytic treatment can be carried out sequentially or as a joint step.

In a first embodiment, the method according to the invention comprises the successive steps of:
(1) providing an aqueous suspension comprising water, silver particles, and at least one ruthenium oxide precursor,
(2) drying the aqueous suspension provided in step (1), and
(3) thermolytically treating, in a non-reducing atmosphere, the dried material obtained after completion of step (2).

In a second embodiment with steps (2) and (3) carried out jointly, the method according to the invention comprises the successive steps of:
(1) providing an aqueous suspension comprising water, silver particles, and at least one ruthenium oxide precursor, and
(2+3) drying and thermolytically treating, in a non-reducing atmosphere, the aqueous suspension provided in step (1).

In step (1) according to both embodiments of the method according to the invention, an aqueous suspension is provided, which comprises water, silver particles, and at least one ruthenium oxide precursor. The aqueous suspension can be in the form of a thin slurry or a pulp-like, paste-like or dough-like mass.

The aqueous suspension can be produced by adding the silver particles to an aqueous solution of the at least one ruthenium oxide precursor and suspending them therein. The reverse addition sequence is also possible.

The weight proportion of the silver particles of the aqueous suspension provided in step (1) of the method according to the invention can be in the range of, for example, 5 to 60 wt. %.

The ruthenium weight proportion of the aqueous suspension provided in step (1) of the method according to the invention can be in the range of, for example, 0.5 to 20 wt. %. The aqueous suspension provided in step (1) of the method according to the invention can be characterized by a weight ratio of the two noble metals ranging, for example, from 1 to 2000 parts by weight of silver: 1 part by weight of ruthenium and generally significantly in favor of the silver.

In addition to the silver particles and the ruthenium oxide precursor(s), the aqueous suspension provided in step (1) of the method according to the invention generally comprises only water and optionally corresponding acid from the ruthenium oxide precursor(s), i.e., said suspension consists at least substantially or preferably only of the silver particles, the ruthenium oxide precursor(s) and water.

In step (2) according to the first embodiment of the method according to the invention, the aqueous suspension provided in step (1) is dried, i.e., water and any other volatile substances that may be present are removed.

The aqueous suspension is evaporated to dryness. Advantageously, the aqueous suspension is agitated during evaporation, for example by stirring and/or shaking and/or rotation, i.e., rotation of the vessel or container containing the aqueous suspension. In general, heating and/or negative pressure are applied during evaporation to remove water and any other volatile substances that may be present. During evaporation, work can be carried out at a temperature ranging, for example, from 40 to 95° C. The material obtained after dryness has been achieved can be crushed if necessary.

In step (3) according to the first embodiment of the method according to the invention, the ruthenium oxide precursor(s) are thermally decomposed to form ruthenium oxide. For this purpose, the material obtained after completion of step (2) and optionally crushed, i.e., the dried, originally aqueous suspension obtained after completion of step (2), is subjected to a thermolytic treatment in a non-reducing atmosphere. For this purpose, the material can be heated, either not in motion or in motion, to a thermolysis temperature, for example ranging from 150 to 1000° C., for example in a static furnace, a fluidized-bed reactor or a rotary kiln.

During step (3), the furnace chamber is expediently flushed with the gas comprising non-reducing properties, or said gas flows through the furnace chamber; the gas flow can also serve to remove gaseous decomposition products. The non-reducing atmosphere can also be pressure-reduced.

In the combined step (2+3) according to a first variant of the second embodiment of the method according to the invention, the aqueous suspension provided in step (1) is dried and thermolytically treated in a non-reducing atmosphere. The aqueous suspension provided in step (1) can pass through, either in motion or not in motion, a temperature profile comprising a drying temperature and a higher thermolysis temperature within a furnace. This can be achieved by passage through a furnace with a temperature gradient comprising a drying temperature and a thermolysis temperature or by working in a furnace with a time-controlled heating or temperature program, which ensures a drying temperature first and then a thermolysis temperature or thermolysis temperature profile. Examples of usable furnace types include static furnaces, fluidized-bed reactors and rotary kilns. In this way the aqueous suspension provided in step (1) can first be dried, i.e., water and any other volatile substances that may be present can be removed, i.e., evaporated to dryness. During evaporation, work can be carried out at a drying temperature ranging, for example, from 40 to 95° C. After drying is complete, the ruthenium oxide precursor(s) is/are thermally decomposed to form ruthenium oxide by immediately being heated further, without intermediate cooling, to the thermolysis temperature, for example ranging from 150 to 1000° C.; i.e., the dried material is subjected to a thermolytic treatment. This drying, as well as the thermolysis immediately thereafter, take place in a non-reducing atmosphere.

Also in the combined step (2+3) according to a second variant of the second embodiment of the method according to the invention, the aqueous suspension provided in step (1) is dried and thermolytically treated in a non-reducing atmosphere. The aqueous suspension provided in step (1) can be exposed, in motion or not in motion, to said thermolysis temperature, for example ranging from 150 to 1000° C., within a furnace. Examples of usable furnace types include static furnaces, fluidized-bed reactors and rotary kilns. The ruthenium oxide precursor(s) are thermally decomposed to form ruthenium oxide. Drying and thermolysis occur practically in parallel or so as to overlap. Work is carried out in a non-reducing atmosphere.

After completion of step (3) according to the first embodiment or of the combined step (2+3) according to both variants of the second embodiment of the method according to the invention and optionally subsequent crushing and/or classification, the particulate material according to the invention is obtained.

The particulate material according to the invention is characterized by a particularly strong antimicrobial effect, as can be determined in conventional inhibition zone tests or by determining the minimum inhibitory concentration from growth curves of microorganisms. In this respect, the invention also relates to the use of the particulate material according to the invention as an additive for the antimicrobial treatment of metal surfaces; coating agents such as varnishes and other paints; plasters; molding compounds; plastics in the form of plastics films, plastics parts, or plastics fibers; textiles or in textile applications; synthetic resin products; ion-exchange resins; silicone products; cellulose-based products; foams; cosmetics; and many others.

The particulate material according to the invention can also be used as a heterogeneous catalyst, for example in the catalysis of the formation of antimicrobially active hydroxyl radicals in aqueous media permitting bacterial growth.

The particulate material according to the invention can be used in the aforementioned uses as a dry powder, as a powder with a desired moisture content or as a suspension.

### Example 1 According to the Invention (Thermolytic Production of a Silver Powder According to the Invention which is Equipped with Ruthenium Oxide and has a Silver:Ruthenium Weight Ratio of 80:20)

An aqueous suspension prepared from 5 g of silver powder (46.4 mmol Ag, silver powder “Ag 300-01” from Heraeus Electronics) and 21.55 g of ruthenium nitrosyl oxalate solution (ruthenium content 5.8 wt. %, 12.4 mmol Ru) was evaporated to dryness using a rotary evaporator (90° C./300 mbar). The dry material was then calcined in a tube furnace for a total of 10 hours in an oxygen atmosphere, first for 4 hours at 150° C. and then for 6 hours at 200° C. The calcined material was then crushed using an agate mortar. Using ICP-OES, a silver:ruthenium weight ratio of 80:20 of the product was determined. XPS confirmed that ruthenium oxide and elemental silver were present on the surface.

### Example 2 According to the Invention (Thermolytic Production of a Silver Powder According to the Invention which is Equipped with Ruthenium Oxide and Has a Silver:Ruthenium Weight Ratio of 80:20)

An aqueous suspension prepared from 5 g of silver powder (46.4 mmol Ag, silver powder “Ag 300-01” from Heraeus Electronics) and 93.98 g of ruthenium acetate solution (ruthenium content 1.3 wt. %, 12.4 mmol Ru) was evaporated to dryness using a rotary evaporator (90° C./300 mbar). The dry material was then calcined in a tube furnace for a total of 10 hours in an oxygen atmosphere, first for 5 hours at 400° C. and then for 5 hours at 700° C. The calcined material was then crushed using an agate mortar. Using ICP-OES, a silver: ruthenium weight ratio of 80:20 of the product was determined. XPS confirmed that ruthenium oxide and elemental silver were present on the surface.

### Testing for Antimicrobial Effect

In separate Erlenmeyer flasks, 30 mL of a culture of methicillin-resistant Staphylococcus aureus (MRSA) in tryptic soy broth (TSB) was adjusted to an optical density of 0.05. Different amounts of the silver powders equipped with ruthenium oxide from Examples 1 and 2 according to the invention ranging from 1 to 50 mg were then weighed in. The samples were incubated in a shaking incubator at 37° C. and 150 rpm. Within 6 hours, the optical density at a wavelength of 600 nm (OD600) was determined at hourly intervals. The inhibition of bacterial growth was indicated by a reduced increase in optical density compared to the control sample. An MRSA culture without the addition of an antimicrobial active substance served as the control sample. In the case of complete inhibition of bacterial growth, no increase in optical density was to be observed. This resulted in a minimum inhibitory concentration for the product from Example 1 according to the invention of 0.7 mg/mL and from Example 2 according to the invention of 1.6 mg/mL.

1. A particulate material which has an average particle size (d50) ranging from 1 to 100 μm, said material comprising silver particles which are equipped with ruthenium oxide and are optionally partially oxidized.

2. The particulate material according to claim 1 having a silver:ruthenium weight ratio ranging from 1 to 2000 parts by weight silver: 1 part by weight ruthenium.

3. The particulate material according to claim 1 consisting of ≥90 to ≤100 wt. % of silver particles equipped with ruthenium oxide and ≥0 to ≤10 wt. % of silver particles and/or ruthenium oxide particles, each present separately.

4. The particulate material according to claim 1 consisting of ≥90 to ≤100 wt. % of silver particles which are equipped with ruthenium oxide and are partially oxidized and ≥0 to ≤10 wt. % of partially oxidized silver particles, non-oxidized silver particles and/or ruthenium oxide particles, each present separately.

5. A method for producing the particulate material according to claim 1 of the present invention by means of a drying process and a thermolytic treatment, which is carried out in a non-reducing atmosphere, of an aqueous suspension comprising water, silver particles, and at least one ruthenium oxide precursor in the form of a ruthenium compound which can be thermally decomposed into ruthenium oxide in a non-reducing atmosphere.

6. The method according to claim 5, wherein the silver particles are those having an average particle size (d50) ranging from 0.5 μm to 50 μm.

7. The method according to claim 5, wherein the non-reducing atmosphere is an oxidizing atmosphere, and wherein the at least one ruthenium oxide precursor is selected from the group consisting of ruthenium nitrosyl nitrate, ruthenium oxalate, ruthenium acetate and ruthenium nitrosyl oxalate.

8. The method according to claim 5, wherein the non-reducing atmosphere is an inert atmosphere, and wherein the at least one ruthenium oxide precursor is selected from the group consisting of ruthenium nitrosyl nitrate and ruthenium nitrosyl oxalate.

9. The method according to claim 5, comprising the successive steps of:
(1) providing an aqueous suspension comprising water, silver particles, and at least one ruthenium oxide precursor,
(2) drying the aqueous suspension provided in step (1), and
(3) thermolytically treating, in a non-reducing atmosphere, the dried material obtained after completion of step (2).

10. The method according to claim 5, comprising the successive steps of:
(1) providing an aqueous suspension comprising water, silver particles, and at least one ruthenium oxide precursor, and
(2+3) drying and thermolytically treating, in a non-reducing atmosphere, the aqueous suspension provided in step (1).

11. The method according to claim 5, wherein the thermolytic treatment is carried out at or above a thermolysis temperature ranging from 150 to 1000° C.

12. A use of a particulate material according to claim 1 an additive for the antimicrobial treatment of metal surfaces; coating agents; plasters; molding compounds; plastics in the form of plastics films, plastics parts or plastics fibers; textiles; textile applications; synthetic resin products;
ion-exchange resins; silicone products; cellulose-based products; foams; and cosmetics.

13. A use of a particulate material according to claim 1 as a heterogeneous catalyst in the catalysis of the formation of hydroxyl radicals in aqueous media permitting bacterial growth.

14. The particulate material according to claim 2 consisting of ≥90 to ≤100 wt. % of silver particles equipped with ruthenium oxide and ≥0 to ≤10 wt. % of silver particles and/or ruthenium oxide particles, each present separately.

15. The particulate material according to claim 2 consisting of ≥90 to ≤100 wt. % of silver particles which are equipped with ruthenium oxide and are partially oxidized and ≥0 to ≤10 wt. % of partially oxidized silver particles, non-oxidized silver particles and/or ruthenium oxide particles, each present separately.

16. The method according to claim 6, wherein the non-reducing atmosphere is an oxidizing atmosphere, and wherein the at least one ruthenium oxide precursor is selected from the group consisting of ruthenium nitrosyl nitrate, ruthenium oxalate, ruthenium acetate and ruthenium nitrosyl oxalate.

17. The method according to claim 6, wherein the non-reducing atmosphere is an inert atmosphere, and wherein the at least one ruthenium oxide precursor is selected from the group consisting of ruthenium nitrosyl nitrate and ruthenium nitrosyl oxalate.

18. A use of a particulate material produced by a method according to claim 5 as an additive for the antimicrobial treatment of metal surfaces; coating agents; plasters; molding compounds; plastics in the form of plastics films, plastics parts or plastics fibers; textiles; textile applications; synthetic resin products; ion-exchange resins; silicone products; cellulose-based products; foams; and cosmetics.
